(19) United States
(12) Patent Application Publication
(10) Pub. No.: US 2026/0314866 A1
(43) Pub. Date: Oct. 15, 2026

(54) APPARATUS AND METHOD FOR PREPARING A MIXTURE IN A CAPSULE

(71) Applicant: Nootrie AG, Zizers (CH)

(72) Inventors: Cédric SANTANA-SIEGENTHALER, Weesen (CH); Marcel Wilhelm HÜPPI, Rorschacherberg (CH)

(21) Appl. No.: 19/485,248

(22) PCT Filed: May 17, 2023
(86) PCT No.: PCT/EP2023/063393

§ 371 Date: Nov. 17, 2025

(51) Int. Cl. A47J 31/40; A47J 31/46; A47J 31/60

(52) U.S. Cl. CPC A47J 31/407; A47J 31/461; A47J 31/60

(57) ABSTRACT

Apparatus (100) for preparing a mixture of a nutrition concentrate and an aqueous liquid in a capsule (200) comprising a capsule holder (101) configured to receive the capsule (200), the capsule (200) comprising a cavity (202), a membrane (202) sealing the cavity (202), and an agitator (203). The apparatus (100) comprises an injection needle (1) configured to pierce the membrane (202) and to inject the aqueous liquid into the cavity (201) of the capsule (200) and a venting needle (2) configured to further pierce the membrane (202) and to inject the liquid into the cavity (201) of the capsule (200). In addition, the apparatus (100) comprises a drive (3) configured to engage with the agitator (203) for mixing the liquid with the nutrition concentrate in in the cavity (201) in a mixing cycle, and a control unit (4) configured to control the liquid supply (31) and the drive (3).

### TECHNICAL FIELD

The present invention refers in a first aspect to an apparatus for preparing a mixture of a nutrition concentrate and an aqueous liquid in a capsule. In a second aspect, the invention refers to a method for preparing the mixture. A third aspect of the invention refers to an injection plate for the apparatus.

### DISCLOSURE OF THE INVENTION

Conventional ways of preparing beverages from nutrition concentrates, such as sports drinks, energy drinks, dietary supplements, soups, or baby formula, are delicate since they require significant amounts of time and attention to measure a right quantity of concentrate, to transfer the concentrate to a glass or bottle without spilling, to mix the concentrate sufficiently with water or any other aqueous liquid, and to clean any equipment used. Moreover, if a packaging of the concentrate is once opened, the quality and solubility of the nutrition concentrate might decrease over time. Hence the conventional preparation of beverages from a nutrition concentrate is on the one hand inconvenient, and on the other hand, it rarely yields in desirable results in terms of a homogeneous solution of the concentrate in any liquid.

EP3536637A1 discloses an apparatus for preparing a beverage that addresses these issues. The apparatus comprises a capsule holder configured to receive a capsule for preparing a beverage. The capsule comprises a housing with an outlet. In addition, the capsule comprises a cavity for containing a powder and an inner membrane between the cavity and the outlet. In addition, the capsule comprises an agitator, comprising a central shaft, and at least one blade attached to the central shaft. The at least one blade comprises at least one blade element for piercing and/or cutting the inner membrane.

The prior art apparatus further comprises a water supply configured to supply water to the capsule. The water supply might comprise an injection needle. Furthermore, the apparatus comprises a motor to drive the agitator. Additionally, the apparatus comprises a control unit to control the water supply and the motor.

For preparing a beverage with this prior art apparatus, a powder is mixed with water inside of the cavity of the capsule while an outlet of the capsule is sealed against the cavity by an inner membrane. In addition, the inner membrane previously sealing the outlet is pierced and/or cute. Additionally, the powder and more water are mixed inside the capsule and the resulting mixture is flowing out from the outlet into e.g. a cup.

The prior art apparatus therefore provides a way to prepare a beverage from a nutrition concentrate. Anyway, some drawbacks remain. In particular, by preparing a beverage by means of said apparatus, spilling of the mixture during the mixing process and during the flushing of the capsule might occur.

The problem to be solved by the present invention is therefore to provide an apparatus and a method to reduce spilling of the mixture of the nutrition concentrate and the aqueous liquid.

This problem is solved by a first aspect of the invention referring to an apparatus for preparing a mixture of the nutrition concentrate and an aqueous liquid and by a second aspect of the invention referring to a method for preparing the mixture. A third aspect of the invention refers to an injection plate for the apparatus according to the first aspect.

The present invention will be described in detail below. It is understood that the various embodiments, preferences and ranges as provided/disclosed in this specification may be combined at will. Further, depending of the specific embodiment, selected definitions, embodiments or ranges may not apply.

Unless otherwise stated, the following definitions shall apply in this specification:

The terms “a”, “an” “the” and similar terms used in the context of the present invention are to be construed to cover both the singular and plural unless otherwise indicated herein or clearly contradicted by the context. The term “containing” shall include all, “comprising”, “essentially consisting of” and “consisting of”.

A first aspect of the invention refers to an apparatus for preparing a mixture of a nutrition concentrate and an aqueous liquid in a capsule, in particular for preparing a beverage. Beverages may be, but are not restricted to sports drinks, energy drinks, dietary supplements, soups, or baby formula. The nutrition concentrate is preferably a powder or grain powder or a syrup or a gel, the aqueous liquid is preferably water, but might further be milk or similar. Powders for preparing the beverage comprise all kinds of granular matter.

The apparatus comprises a capsule holder configured to receive the capsule with the nutrition concentrate. The capsule comprises a cavity comprising the nutrition concentrate, a membrane sealing the cavity, and an agitator arranged within the capsule. The agitator is adapted to agitate the nutrition concentrate alone or a mixture of the nutrition concentrate with the aqueous liquid within the capsule. Furthermore, the apparatus comprises an injection needle configured to pierce the membrane of the cavity and to inject the aqueous liquid into the cavity. In addition, the apparatus comprises a venting needle configured to further pierce the membrane and to vent the cavity. A drive of the apparatus is configured to engage with the agitator arranged within the capsule. The agitator is configured to mix the aqueous liquid with the nutrition concentrate in the cavity, preferably in a mixing cycle. A control unit is configured to control the aqueous liquid supply, in particular configured to supply the aqueous liquid to the injection needle and optionally also to the venting needle, and the drive.

The term mixing cycle might preferably refer to a cycle during which the agitator is active and mixes the nutrition concentrate with the aqueous liquid over a certain time.

In different embodiments, the cavity may contain the nutrition concentrate and any gas, in particular air or nitrogen.

Capsules that comprise agitators at their inside are well known from prior art, e.g. from EP3536637A1.

In different embodiments, the capsule may be a container of cylindrical or conical or cuboid or mixed outer shape. The housing may be manufactured as one part, or composed of several parts.

Advantageously, the capsule comprises further an outlet, or a housing with an outlet, and an inner membrane between the cavity and the outlet.

Advantageously, the agitator comprises means for piercing and/or cutting the inner membrane. In particular, the agitator comprises a central shaft, and at least one blade attached to the central shaft. The at least one blade comprises at least one blade element for piercing and/or cutting the inner membrane, to open the cavity and allow the mixture to flow out through the outlet. The central shaft is in particular used to contact the agitator from outside the capsule, e.g. by the drive of the apparatus. For that purpose, the central shaft may comprise coupling means to reversibly engage with the drive. The blade element may e.g. be a spike, a stud, or a knife, configured to pierce and/or cut the inner membrane, when pushed onto, or dragged along the latter.

Advantageously, when rotated, the agitator mixes or stirs the nutrition concentrate in the cavity. In particular, the agitator is used for preparing the mixture of nutrition concentrate and the aqueous liquid in a first state while the inner membrane still is intact. The agitator may also be used to pierce and/or cut one or more openings into the inner membrane, transferring the capsule to a second state, in which the mixture may pour from the cavity through the opening in the inner membrane to the outlet, and finally out of the outlet. The piercing or cutting may be effected by an axial movement of the agitator, which may be accompanied by a rotation of the agitator. As a result, the mixture may flow out of the capsule via the outlet, while the agitator may be used to mix the remaining concentrate with more liquid.

In a further advantageous embodiment, the capsule holder may be configured in a way that an upper rim of the capsule can be shifted into the apparatus, in particular via rungs mounted to the apparatus.

Advantageously, the aqueous liquid supply may be fed by a liquid tank, in particular a water tank, of the apparatus, or it may be fed via a connection with a liquid pipe. Preferably, the aqueous liquid supply comprises pumping and measuring means, and is controlled by the control unit, in order to supply a correct amount of liquid into the capsule.

Further advantageously, the drive might be an electric motor with speed and sense of rotation being controlled by the control unit. Preferably the drive is configured to drive a motor shaft, which is configured to engage with the agitator, respectively with a central shaft of the agitator, in a preferred embodiment of the capsule as mentioned above. In a further advantageous embodiment, the drive respectively the motor shaft may comprise coupling means for reversibly coupling to the central shaft of the agitator. The coupling may be achieved by a vertical movement of the motor shaft.

Advantageously, the injection needle and/or the venting needle are embodied as hollow cylinders with a metallic cross at the tip, with openings or recesses around the metallic cross. In a further preferred embodiment of the injection and/or venting needles, these are hollow needles.

Advantageously, the setting of the apparatus with the injection needle and the venting needle allows to avoid or at least reduce spilling during the preparation of the mixture in the cavity of the capsule as explained in the following: By piercing the membrane of the cavity with the venting needle before the liquid is injected, the otherwise preferably hermetically sealed cavity is vented. This allows injection of the liquid by means of the injection needle without creating an overpressure in the cavity. Without venting the capsule, if the liquid is injected into the cavity, the pressure in the cavity would increase and in a consequence, the cavity or the capsule might get damaged or the mixture might spill through a piercing spot of the injection needle. In particular, the spot where the injection needle respectively the venting needle pierces the membrane is the respective piercing spot.

Advantageously, the venting needle is only venting the cavity when the injection needle is injecting the aqueous liquid and at the same time the inner membrane is still intact, that means the inner membrane is not pierced or cut yet.

The apparatus comprising the venting needle therefore solves the problem of avoiding the spilling of the mixture of the nutrition concentrate and the aqueous liquid. The venting of the capsule respectively the cavity before injecting the liquid prevents that an overpressure builds up in the cavity respectively in the capsule.

In a further advantageous embodiment of the invention, the apparatus comprises a first valve to open or close a venting channel for the venting needle. The first valve is in a venting position if the venting channel is open. in particular, the venting channel connects the venting needle with the environment or with a drip tray, in particular to collect spilling aqueous liquid from the capsule. In an advantageous intended use of the apparatus, when the injection needle and the venting needle are pierced into the membrane of the cavity and the aqueous liquid is injected into the cavity through the injection needle, the first valve is open to keep the venting channel open and thereby venting the cavity, to prevent a pressure built-up within the cavity. In particular, during the mixing cycle, to prevent spilling of the mixture into the venting needle or the venting channel, the first valve is closing the venting channel in order to prevent any mixture entering the channel. For entering the venting channel, if the first valve is closed, the liquid would need to work against the pressure in the channel.

In particular, the first valve is therefore in a venting position only during the injection of the liquid by the injection needle while the inner membrane is still intact.

In a further advantageous embodiment of the invention, the apparatus comprises sealing means around the injection needle and/or the venting needle. These sealing means might be integrated into the injection plate if there is any. The sealing means are configured to seal the piercing spot of the injection needle and/or the venting needle into the membrane. Therefore, the sealing means seal the environment and the apparatus itself from spilling if the injection needle and/or the venting needle is pierced into the membrane. Sealing means might preferably be sealing rings or sealing lips. Advantageously, the sealing means are arranged circular around the respective injection needle tip and/or venting needle tip directed towards the membrane surface.

In a further advantageous embodiment of the invention, the apparatus comprises an injection plate. Preferably, the injection plate is removably mountable to the apparatus. In addition, the injection plate comprises the injection needle and the venting needle. In particular, the injection plate is configured to be attachable to the membrane of cavity of the capsule, such that the injection needle the venting needle pierce the membrane, if the injection plate is brought in contact with the membrane. The injection plate might be arranged just directly above the capsule holder, leaving space for the capsule to be inserted. If the injection plate is pressed against the capsule, respectively against the membrane of the cavity and thereby the injection needle and the venting needle are pressed against the membrane, such that the injection needle and the venting needle pierce the membrane.

In a further advantageous embodiment of the invention, the piercing spot of the injection needle and/or the venting needle in the membrane are sealed towards the environment. Sealing means for sealing the respective piercing spot might be any sealings, in particular sealing rings or sealing lips surrounding the respective piercing spot. In particular, the sealing means seal the piercing spots against parts of the apparatus, to prevent spilling of the mixture onto parts of the apparatus. In particular, the sealing means seal are integrated into the injection plate that is pressed against the membrane during the mixing cycle.

In a further advantageous embodiment of the injection plate, sealings, e.g. sealing rings or sealing lips are arranged such that they surround the injection needle and/or the venting needle in a way that if the injection plate is pressed against the membrane of the cavity, the injection needle and the venting needle pierce the membrane and at the same time the sealings are pressed against the membrane to seal the respective injection spot of the injection needle and/or venting needle.

In particular, after the nutrition concentrate and the aqueous are mixed into a mixture, the inner membrane of the capsule is cut open as described above and the mixture is flushed out of the capsule through the outlet of the capsule.

Therefore, the apparatus is advantageously embodied to comprise the venting needle that is further configured to not only vent the capsule but also to inject aqueous liquid into the capsule, to accelerate the process of flushing the mixture out of the cavity. In addition, even after flushing the mixture out of the cavity, the injection needle and the venting needle might supply further aqueous liquid that might flush through the outlet into e.g. a cup, to dilute the mixture (in the cup) even further. In particular, additionally, gas might be flushed through the cavity to press the leftover mixture through the outlet out of the cavity.

In a further advantageous embodiment of the invention, the apparatus comprises a second valve that is adapted to control the aqueous liquid supply to the venting needle.

A further advantageous embodiment of the invention comprises a gas supply. The gas supply is adapted to blow out the injection and/or the venting needle after the mixing cycle and/or after the flushing of the cavity, to clean them. The additional gas supply enables the self-cleaning of the apparatus. In particular, by flushing gas through the injection needle, the venting needle, the venting channel and/or the connection between the venting needle and the drip tray, all parts of the apparatus that might be necessary to dry are dried. A user preferably only needs to wash the drip tray for cleaning the apparatus.

In particular, the apparatus comprises therefore a third valve which is adapted to switch between an aqueous liquid supply and the gas supply.

In a further advantageous embodiment of the invention, the apparatus might comprise more than one venting needle, in particular might comprise two venting needles, wherein each is configured to further pierce the membrane of the capsule to vent the capsule.

In a further advantageous embodiment of the invention, the apparatus comprises further a positioning motor. The positioning motor is configured to move a mixing unit from an upper position to a lower position in axial direction relative to the capsule holder. The mixing unit comprises the drive and the injection plate with the injection needle and the venting needle.

In an advantageous embodiment of the invention, the positioning motor is preferably shiftable in an axial direction between an upper and a lower axial position, and in particular the shift between the upper and the lower axial position is controlled by the control unit. In different embodiments, the axial shift is caused hydraulically or through an electric servo motor. In that way, the axial shift, being responsible for piercing and venting and/or cutting of the inner membrane, is performed in a precise and controlled manner.

Advantageously, in an intended use of the apparatus, if the mixing unit is positioned in an upper position, the drive engages with the agitator in order to conduct the mixing cycle. If the mixing unit is positioned in a lower position by means of the positioning motor, by engaging the drive with the agitator, means of the agitator configured to pierce and/or cut an opening in the membrane of the capsule are enabled to open the inner membrane.

A second aspect of the invention refers to a method for preparing a mixture of a nutrition concentrate and an aqueous liquid in the capsule, in particular for preparing a beverage with an apparatus according to the first aspect.

The method comprises:
piercing the venting needle into the membrane of the cavity to vent the capsule,
piercing the injection needle into the membrane of the cavity,
injecting the aqueous liquid into the capsule via the injection needle, and
activating the drive to engage with the agitator in the capsule, to mix the aqueous liquid with the nutrition concentrate in a mixing cycle.

In a further advantageous embodiment of the inventive method, the step of injecting the aqueous liquid into the cavity and the step of activating the drive to mix the aqueous liquid with the nutrition concentrate in a mixing cycle are alternating method steps, alternating multiple times, at least two times

In a further advantageous embodiment of the inventive method, if the inner membrane is not yet cut or pierced open, the injection of aqueous liquid into the cavity via the injection needle pauses while the drive activates the agitator in the capsule. This means that while the agitator in the capsule is mixing the mixture in the cavity, the injection of liquid via the injection needle pauses. Therefore, no additional liquid is injected into the capsule during the agitation step or during the mixing cycle.

In a further advantageous embodiment of the inventive method, the first valve is open to open the venting channel while the aqueous liquid is injected into the cavity to vent the capsule. Optionally, the first valve is closed during the mixing cycle in order to prevent the mixture spilling into the venting needle and the venting channel.

In a further advantageous embodiment of the inventive method, after the mixing cycle, the injection of aqueous liquid is paused and the drive stops, to allow the nutrition concentrate and the aqueous liquid in the capsule to relax after each mixing cycle, in particular if there are multiple mixing cycles.

In a further advantageous embodiment of the inventive method, the method further comprises the steps of:
activating the drive to pierce and/or cut the inner membrane of the cavity by engaging the drive with the agitator of the capsule, in particular by means of engaging the drive with the central shaft of the agitator, and
by means of supplying further aqueous liquid through the injection needle and/or the venting needle, flushing the mix of the nutrition concentrate and the aqueous liquid through the outlet out of the capsule, and advantageously
opening the third valve to enable the aqueous liquid flow through the injection needle and the venting needle for flushing the cavity, if the inner membrane is already pierced or cut open.

Advantageously, there are two injection steps in the method, before and after mixing of the aqueous liquid with the nutrition concentrate, which flushing steps prepare the mixture and empty the capsule respectively the cavity:
First injection step: piercing the injection needle and the venting needle into the membrane of the cavity. The first valve is open to vent the cavity via the venting needle and the venting channel. Aqueous liquid is injected into the cavity via the injection needle, while the inner membrane is still intact and not yet pierced. After an in particular predefined amount of liquid is injected into the capsule, the drive is activated to engage with the agitator and to move the agitator such that the liquid and the nutrition concentrate in the capsule is mixed in a mixing cycle. Multiple mixing cycles are possible. The agitator might be paused between the mixing cycles. Further liquid might be injected via the injection needle between the mixing cycles or injection might be paused. Preferably, the first valve is closed during the mixing cycle to prevent that the mixture spills into the venting needle or the venting channel.
Second injection step: after the mixture in the cavity is prepared as explained above for the first injection step, the drive is activated to engage with the agitator to cut open the inner membrane with the piercing means of the agitator to open the cavity towards the outlet. Now, to flush the mixture through the outlet out of the cavity, an in particular predefined amount of aqueous liquid might be injected via the injection needle and/or the venting needle. In particular, the second valve therefore is in a position to allow the bypass of the liquid into the venting needle. In addition, the first valve is open to allow the liquid to pass the venting channel towards the venting needle. In addition, to completely empty the cavity, gas is flushed through the injection needle and the venting needle into the cavity of the capsule. For the gas to be flushing through the system, the third valve is preferably put into a position to allow the gas flow. In addition, the second valve is preferably open to allow the bypass of the gas through the venting channel and the venting needle and the first valve is open to allow the gas flowing through the venting channel. By flushing the cavity with gas, the rest of the mixture is flushed out of the cavity.

In a further advantageous embodiment of the inventive method, the method further comprises the steps:
conducting the mixing cycle while the mixing unit is positioned in the upper position,
activating the drive to pierce and/or cut open the inner membrane of the capsule to flush the mix of aqueous liquid and nutrition concentrate through the outlet out of the cavity, respectively out of the capsule, while the mixing unit is positioned in the lower position.

In a further advantageous embodiment of the invention, the method further comprises the step of cleaning the injection needle and/or the venting needle by flushing the respective needle with aqueous liquid and/or dry blowing the respective needle with gas. In particular, the second valve is switching between aqueous liquid supply and gas supply for the respective cleaning step. In particular is switching between a supply from a aqueous liquid tank, e.g. a water tank, and a gas tank, e.g. an air or nitrogen tank. a further advantageous embodiment of the inventive method, the method further comprises the step of flushing the connection between the venting needle and the drip tray, in particular also flushing the venting channel, for cleaning the same. This method step is preferably conducted if the first valve is open.

In a further f advantageous embodiment of the inventive method, the steps of injecting the liquid into the capsule via the injection needle and/or the venting needle and the step of driving the agitator in the capsule with the motor are carried out in series.

In particular advantageous, the first method step is to pierce the membrane of the capsule with the venting needle, second to inject the aqueous liquid by means of the injection needle into the capsule, and third to engage the drive with the agitator. Preferably, the fourth step is to cut open the membrane to produce an opening. Further preferably, a fifth step is flush the mixture through the opening out of the capsule and into e.g. a cup by injecting further aqueous liquid or gas into the capsule via the injection needle and preferably also via the venting needle. Preferably, in a sixth step, gas, preferably air, might be flushed through the injection needle and/or the venting needle to clean or flush the same. In a last optional seventh step, the injection needle and/or the venting needle might be cleaned by rinsing them with the aqueous liquid, in particular with water.

For a preferred embodiment of the invention, the valves might each be a 3-way-valve.

A third aspect of the invention refers to an injection plate for an apparatus according to the first aspect. Preferably, the injection plate is in particular removably mountable to the apparatus.

Removably means in particular that the plate can be removed without using any tools to remove it. The plate might be mounted to the apparatus by means of a coupling or plugging mechanism. Therefore, the injection plate might be easily removed for cleaning or maintenance services.

In addition, the injection plate comprises the injection needle and the venting needle, respectively forms the injection needle and the venting needle. In particular, the injection plate is configured to be attachable to the membrane of the capsule and to arrange adjacent to the membrane in the intended use of the injection plate together with the apparatus. The injection needle and the venting needle face into the same direction, such that if the injection plate is mounted for its intended use to the apparatus, the injection needle and the venting needle both face the membrane of the capsule.

The intended use means that the plate is pressed against the membrane of the capsule with the injection needle and the venting needle facing the membrane such that they are able to pierce the membrane.

In addition, a preferred embodiment of the injection plate further comprises a duct for the drive to pass through if the plate is mounted to the apparatus. If the injection plate is mounted to the apparatus, the drive might pass through the duct and engage with the agitator, respectively with the central shaft of the agitator, of the capsule, while the injection needle and the venting needle pierce the membrane of the cavity. In particular, the duct is a circular recess in the injection plate, with a longitudinal axis parallel to an axis of the injection needle and the venting needle.

A further advantageous embodiment of the injection plate comprises sealings around the injection needle and/or venting needle, in particular sealing lips or sealing rings, to prevent that the mixture is spilling and contaminating the apparatus and its surroundings. In the intended use of the injection plate, the sealings around the respective needle get in touch with the membrane of the capsule and therefore seal an area around the respective piercing spot of the injection and/or venting needle in the membrane towards to environment. The sealings are thus adapted to prevent spilling of capsule contents through the piercing spots of the injection needle and/or the venting needle. Therefore, even though if some of the aqueous liquid, concentrate or mixture spills through the piercing spot of the membrane, the apparatus and the environment are not contaminated.

In addition, the injection plate might further comprise sealing means around the duct for the drive to seal an engagement spot, where the drive engages with the agitator, respectively with the central shaft. Also here, the sealing prevents spilling of any capsule contents to the environment, while the drive engages with the agitator, respectively the central shaft of the agitator.

Other advantageous embodiments are listed in the dependent claims as well as in the description below.

### BRIEF DESCRIPTION OF THE DRAWINGS

The invention will be better understood and objects other than those set forth above will become apparent from the following detailed description thereof. Such description makes reference to the annexed drawings, wherein:

FIG. 1 shows a schematic diagram of an advantageous embodiment of the apparatus according to a first aspect of the invention to conduct a method according to a second aspect of the invention;

FIG. 2 shows a schematic diagram of a further advantageous embodiment of the apparatus according to a first aspect of the invention to conduct a method according to a second aspect of the invention;

FIG. 3 shows a schematic figure of an advantageous embodiment of an injection plate according to a third aspect of the invention; and

FIG. 4 shows a capsule with an agitator and a membrane.

### MODES FOR CARRYING OUT THE INVENTION

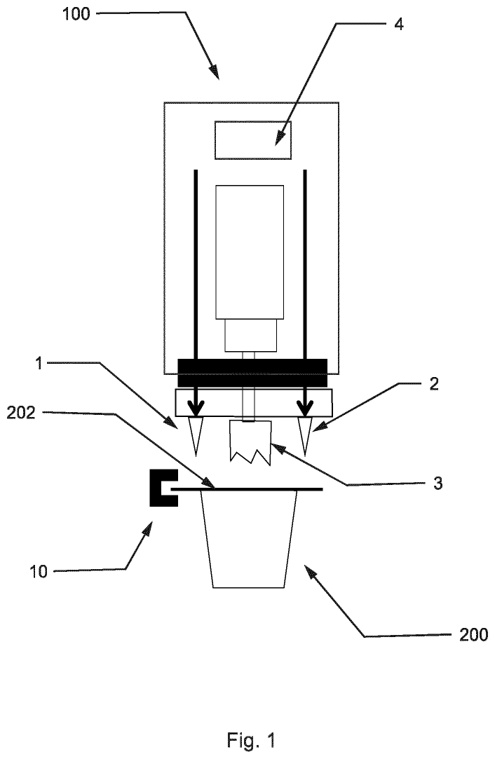

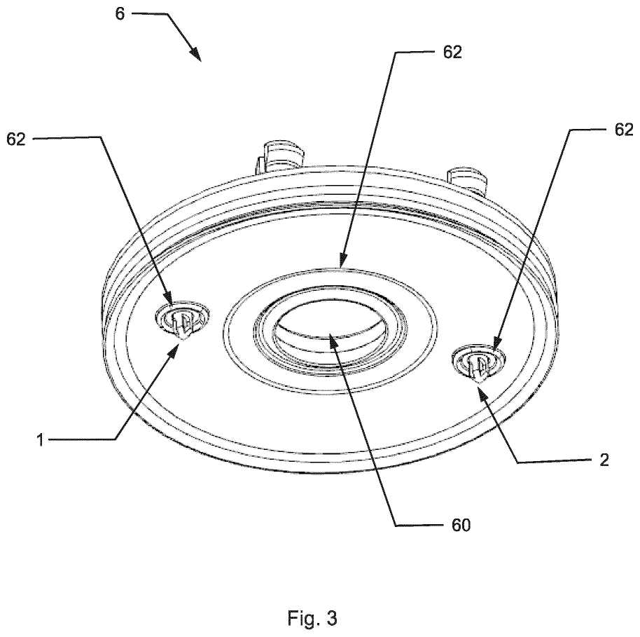

FIG. 1 discloses an advantageous embodiment of an apparatus 100 for preparing a mixture of a nutrition concentrate and an aqueous liquid in a capsule 200 according to a first aspect of the invention. The apparatus 100 comprises a capsule holder 101 configured to receive the capsule 200. The capsule 200 is a capsule 200 with a cavity 201 comprising the nutrition concentrate and a membrane 202 for sealing the cavity 201 as well as an agitator 203. An exemplary capsule 200 that could be used with such an apparatus 100 is shown in FIG. 3. The apparatus 100 comprises further an injection needle 1 configured to pierce the membrane 202 and to inject the aqueous liquid into the cavity 202 of the capsule 200 and a venting needle 2 configured to further pierce the membrane 202 of the capsule 200 and to vent the cavity 201. In addition, the apparatus 100 comprises a drive 3 configured to engage with the agitator 203, respectively with the central shaft of the capsule 200, for mixing the aqueous liquid with the nutrition concentrate in the cavity 201 in a mixing cycle. In addition, the apparatus 100 comprises a control unit 4, configured to control the aqueous liquid supply and the drive 3. The connections between the control unit 4 and the drive 3 as well as the injection needle 1 are not shown in the figure. Anyway, a person skilled in the art would know how to connect the same. Advantageously, the liquid supply may be an additional liquid tank that is not shown in the figure. Further advantageously, the liquid tank might be a connection to a liquid pipe of a whole liquid system, e.g. a connection to a water tap.

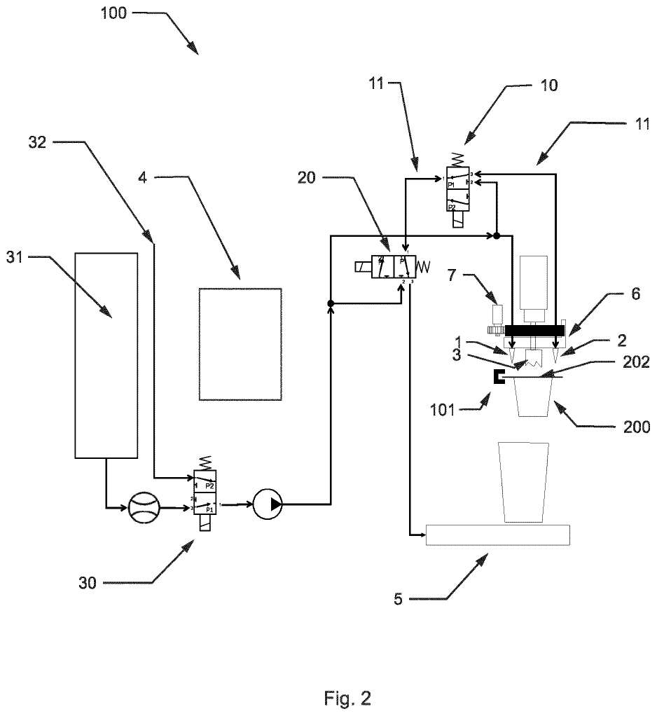

As shown in FIG. 2, the apparatus might further advantageously comprise a first valve 10 configured to open a venting channel for the venting needle 2 during the injection of the aqueous liquid into the cavity and to close the venting channel during the mixing cycle.

Further advantageously, the venting needle 2 respectively the venting channel is connected to a drip tray 5. The drip tray 5 collects spilling aqueous liquid from the capsule 200.

In a further advantageous embodiment of the invention, the venting needle 2 is further configured to supply aqueous liquid into the capsule 200. In particular, the apparatus 100 comprises therefore a second valve 20 that is adapted to control the aqueous liquid supply to the venting needle 2. The second valve is therefore configured to bypass some of the liquid to the venting channel 11, and in particular in reverse direction through valve 1, to supply the venting needle 2 with the aqueous liquid. In a further advantageous embodiment, the apparatus 100 comprises further a gas supply 32 that is adapted to blow out the injection needle 1 and/or the venting needle 2. Advantageously, the apparatus 100 comprises a third valve 30, adapted to switch between an aqueous liquid supply 31 and the gas supply 32. The aqueous liquid supply 31 might preferably be a water tank. The gas supply 32 might preferably be an air tank or nitrogen tank.

In a further advantageous embodiment of the apparatus, the apparatus 100 might comprise more than one venting needles 2.

Further advantageously, the apparatus 100 might comprise an injection plate 6. The injection plate 6 might be removably mountable to the apparatus 100. The injection plate 6 might comprise the injection needle 1 and the venting needle 2.

In a further advantageous embodiment, the apparatus 100 comprises a positioning motor 7. The positioning motor 7 is advantageously configured to move a mixing unit comprising the drive 3 and the injection plate 6 comprising the injection needle 1 and the venting needle 2. The mixing unit is movable from an upper position to a lower position in axial direction relative to the capsule holder 101. In an intended use of the apparatus 100 a capsule 200 is placed in the capsule holder 101, wherein the capsule comprises a housing with an outlet and an inner membrane between the cavity and the outlet. In addition, the capsule comprises an agitator with means for piercing and/or cutting the inner membrane. In the upper position, the drive 3 engages with the agitator 203 in order to conduct the mixing cycle and the injection needle and the venting needle pierce the membrane. In the lower position, means of the agitator 201 configured to pierce and/or cut the inner membrane of the cavity 200 are in touch with the inner membrane to cut it.

The apparatus 100 according to an advantageous embodiment as shown in FIG. 1 or FIG. 2 is adapted to conduct the method steps according to the second aspect of the invention.

In particular, the apparatus 100 is adapted to prepare a mixture of a nutrition concentrate and an aqueous liquid in a capsule 200, in particular for preparing a beverage, with an apparatus (100) according to one of the preceding claims, comprising the steps:
piercing the venting needle (1) into the membrane of the cavity to vent the cavity (200),
piercing the injection needle (2) into the membrane of the cavity,
injecting the aqueous liquid into the cavity (200) via the injection needle (1), and
activating the drive (3) to engage with the agitator (201) in the capsule, to mix the aqueous liquid with the nutrition concentrate in a mixing cycle.

Further advantageously, the step of injecting the aqueous liquid into the cavity 201 and the step of activating the drive 3 to mix the aqueous liquid with the nutrition concentrate in the mixing cycle are alternating method steps, alternating multiple times, at least two times.

Further advantageously, the injection of aqueous liquid into the cavity 201 via the injection needle 1 pauses while drive 3 is activating the agitator 201 in the capsule 200.

Further advantageously, the first valve 10 is open while the aqueous liquid is injected into the capsule 200 to vent the capsule 200, and/or wherein during the mixing cycle, the first valve 10 is closed.

Further advantageously, after the mixing cycle, the injection of aqueous liquid is paused and the drive 3 stops.

A further advantageous method for the apparatus according to a further embodiment of the invention comprises further the step of activating the drive to pierce and/or cut an opening in the inner membrane 106 of the capsule 200, and by means of supplying further aqueous liquid through the injection needle 1 and/or the venting needle 2. Thereby, flushing the mix of the nutrition concentrate and the aqueous liquid through the outlet 204 out of the capsule 200.

A further advantageous method comprises the step of conducting the mixing cycle while the mixing unit is positioned in the upper position. In addition the step of activating the drive 3 to pierce and/or cut open the inner membrane 205 of the capsule 200 to flush the mix of aqueous liquid and nutrition concentrate out of the cavity 201, while the mixing unit is positioned in the lower position.

A further advantageous embodiment of the invention comprises the step of cleaning the injection needle and/or the venting needle by flushing the respective needle with aqueous liquid and/or dry blowing the respective needle with gas, in particular from the gas supply 32.

A further advantageous method comprises the step of flushing the connection between the venting needle 1, in particular the venting channel 11 and the drip tray 5.

FIG. 3 shows an advantageous embodiment of the injection plate 6 for an apparatus 100 according to the first aspect of the invention.

The injection plate 6 is in particular removably mountable to the apparatus 100. The injection plate 6 comprises the injection needle 1 and the venting needle 2.

Preferably, the injection needle 1 and the venting needle 2 are formed as metallic needles with a sharp metallic cross at the very end to pierce the membrane 202 of the capsule 200. Little recesses or holes are arranged around the metallic crosses at the very end of the respective needle 1, 2 and serve as liquid and/or gas inlet and outlet. Further advantageously, the injection plate comprises a duct 60 configured to pass through with the drive 3 in an intended use of the injection plate 6 if mounted to the apparatus 100. The duct 60 enables the engagement of the drive 3 with the agitator 201 of the capsule.

The injection plate 6 might further comprise sealings 62 arranged around the injection needle 1 and/or the venting needle 2 and/or the duct 60. The sealings prevent spilling of capsule content from piercing spots of the injection needle 1 and/or the venting needle 2 and/or from an engagement spot, where the drive 3 engages with the agitator 203.

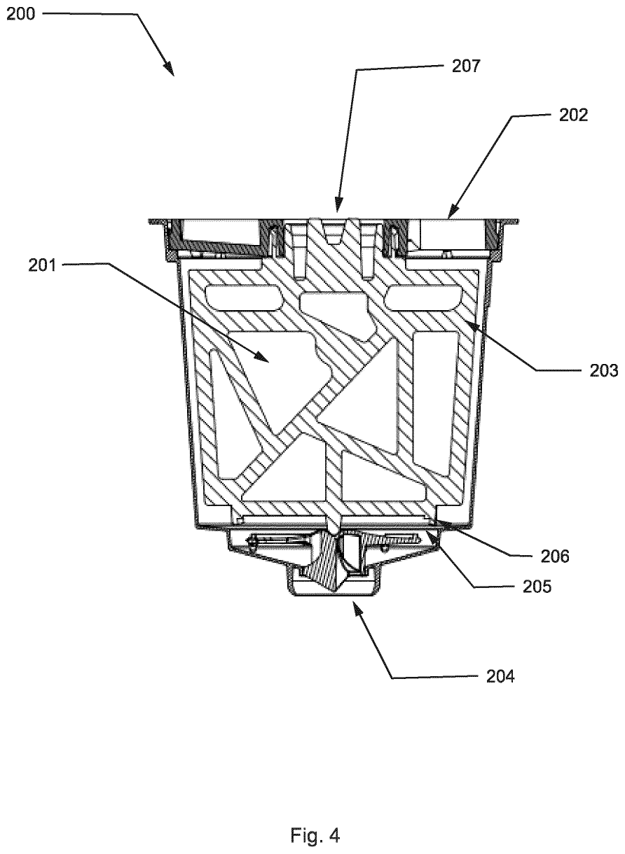

FIG. 4 shows an embodiment of a capsule 200 as it might fit in an apparatus 100 according to the first aspect of the invention. The capsule 200 is shown to better understand the mechanisms of the apparatus 100. The capsule 200 comprises a cavity 201 comprising the nutrition concentrate, a membrane 202 sealing the cavity 201, and an agitator 203 arranged within the capsule.

Advantageously, the capsule 100 comprises further an outlet 204, and an inner membrane 205 arranged between the cavity 201 and the outlet 204.

Advantageously, the agitator 203 comprises means 206 for piercing and/or cutting the inner membrane 205. In particular, the agitator 203 comprises a central shaft 207, and at least one blade attached to the central shaft 206. The at least one blade comprises at least one blade element 206 for piercing and/or cutting the inner membrane, to open the cavity 201 and allow the mixture to flow out through the outlet 204. The central shaft 207 is in particular used to contact the agitator 201 from outside the capsule, e.g. by the drive 3 of the apparatus 100. For that purpose, the central shaft 207 may comprise coupling means to reversibly engage with the drive 3. The blade element 206 may e.g. be a spike, a stud, or a knife, configured to pierce and/or cut the inner membrane 205, when pushed onto, or dragged along the latter.

Advantageously, when rotated, the agitator 203 mixes or stirs the nutrition concentrate in the cavity 201. In particular, the agitator is used for preparing the mixture of nutrition concentrate and the aqueous liquid in a first state while the inner membrane 205 still is intact. The agitator may also be used to pierce and/or cut one or more openings into the inner membrane 205, transferring the capsule 200 to a second state, in which the mixture may pour from the cavity 201 through the outlet 204. The piercing or cutting may be effected by an axial movement of the agitator 203, which may be accompanied by a rotation of the agitator 203. As a result, the mixture may flow out of the capsule 200 via the outlet 204, while the agitator 203 may be used to mix the remaining concentrate with more liquid.

1. An for preparing a mixture of a nutrition concentrate and an aqueous liquid in a capsule, in particular for preparing a beverage, comprising
a capsule holder configured to receive the capsule, wherein the capsule comprises:
a cavity comprising the nutrition concentrate,
a membrane sealing the cavity, and
an agitator;
an injection needle configured to pierce the membrane and to inject the aqueous liquid into the cavity of the capsule,
a venting needle configured to further pierce the membrane of the capsule and to vent the cavity,
a drive configured to engage with the agitator for mixing the aqueous liquid with the nutrition concentrate in the cavity in a mixing cycle,
a control unit configured to control an aqueous liquid supply and the drive.

2. The apparatus according to claim 1 comprising a first valve configured to open a venting channel for the venting needle during the injection of aqueous liquid into the cavity and to close the venting channel during the mixing cycle.

3. The apparatus according to claim 1, wherein the venting needle respectively the venting channel is connected to a drip tray to collect spilling aqueous liquid from the capsule.

4. The apparatus according to claim 1, wherein the venting needle is further configured to supply aqueous liquid into the capsule,
in particular, wherein the apparatus comprises a second valve adapted to control the aqueous liquid supply to the venting needle.

5. The apparatus according to claim 1, further comprising a gas supply adapted to blow out the injection and/or the venting needle and/or the venting channel,
in particular, wherein the apparatus comprises a third valve, adapted to switch between an aqueous liquid supply and the gas supply.

6. The apparatus according to claim 1, comprising more than one venting needle, in particular comprises two venting needles, each configured to further pierce the membrane of the capsule and to vent the capsule.

7. The apparatus according to claim 1, comprising an injection plate, in particular a removably mounted injection plate, comprising the injection needle and the venting needle.

8. The apparatus according to claim 7, comprising a positioning motor, configured to move a mixing unit comprising:
the drive, and
the injection plate comprising the injection needle and the venting needle, from an upper position to a lower position in axial direction relative to the capsule holder,
wherein for the intended use of the apparatus, the capsule is placed in the capsule holder, the capsule further comprising:
an outlet,
an inner membrane between the cavity and the outlet, and
an agitator with means for piercing and/or cutting the inner membrane,
wherein
the upper position is where:
the drive engages with the agitator in order to conduct the mixing cycle, and
the injection needle and the venting needle pierce the membrane, and
the lower position is where:
means of the agitator configured to pierce and/or cut the inner membrane of the cavity are in touch with the inner membrane to cut it.

9. A method for preparing a mixture of a nutrition concentrate and an aqueous liquid in a capsule, in particular for preparing a beverage, with an apparatus according to claim 1, comprising:
piercing the venting needle into the membrane of the cavity to vent the cavity,
piercing the injection needle into the membrane of the cavity,
injecting the aqueous liquid into the cavity via the injection needle, and
activating the drive to engage with the agitator in the capsule, to mix the aqueous liquid with the nutrition concentrate in a mixing cycle.

10. The method according to claim 9, wherein the step of injecting the aqueous liquid into the cavity and the step activating the drive to mix the aqueous liquid with the nutrition concentrate in the mixing cycle are alternating method steps, alternating multiple times, at least two times.

11. The method according to claim 9, wherein the injection of aqueous liquid into the cavity via the injection needle pauses while the drive is activating the agitator in the capsule.

12. The method according to claim 9, comprising:
opening the first valve the aqueous liquid is injected into the capsule to vent the capsule, and/or
closing the first valve during the mixing cycle.

13. The method according to claim 9, comprising: pausing the injection of aqueous liquid into the cavity via the injection needle and pausing the drive after the mixing cycle, in particular after each mixing cycle if there are multiple.

14. The method according to claim 9, further comprising:
activating the drive to pierce and/or cut an opening in the inner membrane of the capsule, and
by means of supplying further aqueous liquid through the injection needle and/or the venting needle, flushing the mix of the nutrition concentrate and the aqueous liquid through the outlet out of the capsule, in particular
opening the third valve to enable the aqueous liquid flow through the injection needle and the venting needle for flushing the cavity.

15. The method according to claim 9, comprising:
conducting the mixing cycle while the mixing unit is positioned in the upper position, and
activating the drive to pierce and/or cut open the inner membrane of the capsule to flush the mix of aqueous liquid and nutrition concentrate out of the cavity, while the mixing unit is positioned in the lower position.

16. The method according to claim 9, further comprising cleaning of the injection needle and/or the venting needle by:
flushing the respective needle with aqueous liquid, and/or
dry blowing the respective needle with gas, in particular
opening the third valve to switch from aqueous liquid supply to gas supply.

17. An injection plate for an apparatus according to claim 7, in particular a removably mountable injection plate,
comprising the injection needle and the venting needle and
adapted to arrange adjacent to the membrane such that in an intended use of the apparatus, the injection plate the injection needle and the venting needle pierce the membrane.

18. The injection plate according to claim 17, further comprises sealings arranged around the injection needle and/or venting needle of the capsule adapted to prevent spilling of capsule contents from piercing spots of the injection needle and/or the venting needle.
